(19) United States
(12) Patent Application Publication
(10) Pub. No.: US 2023/0226625 A1
(43) Pub. Date: Jul. 20, 2023

(54) MILLING TOOL AND COOLANT SLEEVE THEREFOR

(71) Applicant: ISCAR, LTD., TEFEN (IL)

(72) Inventors: HERBERT VOLK, ETTLINGEN (DE); RUDI WILLI MEPPIEL, ETTLINGEN (DE); MATTHIAS GUTEWORT, ETTLINGEN (DE); CHEN BALBES, KIRYAT ATA (IL)

(73) Assignee: ISCAR, LTD., TEFEN (IL)

(21) Appl. No.: 18/155,802

(22) Filed: Jan. 18, 2023

Related U.S. Application Data
(60) Provisional application No. 63/301,296, filed on Jan. 20, 2022.

(51) Int. Cl. B23C 5/28; B23C 5/00; B23C 9/00

(52) U.S. Cl. CPC B23C 5/281; B23C 5/006; B23C 9/005

(57) ABSTRACT

A milling tool having a shank portion and a head portion extending from the shank portion. A head internal surface of the head portion is formed with a peripherally extending head coolant obstruction arrangement comprising a head ridge which extends in a rearward direction more than an adjacent head portion of the head internal surface located in a radially-inward direction more than the head ridge.

### RELATED APPLICATIONS

The present application claims priority to U.S. Provisional Patent Application No. 63/301,296 filed Jan. 20, 2022. The contents of the aforementioned application are incorporated by reference in their entirety.

### FIELD OF THE INVENTION

The subject matter of the present application relates to a milling tool, coolant sleeve (hereinafter also called “sleeve” for conciseness) configured to surround a shank of the milling tool and provide coolant to the milling tool, as well as a tool assembly comprising same.

### BACKGROUND OF THE INVENTION

Milling tools of the present invention were developed as an improvement of existing milling tools for optical lens production.

Such existing optical lens milling tools operate at extremely high rotational speeds (for example, but not limited to, 35,000 RPM). They typically have superhard material cutting elements cutting elements brazed to cutting element recesses, for example PCD or CBN. Generally speaking, the name “superhard materials” is intended to exclude common materials used for cutting inserts such as “cemented carbide” and the like. However, the present invention may indeed use cemented carbide material, and replaceable, indexable cutting inserts, even though preferred embodiments use brazed superhard cutting elements (for the application mentioned above).

Further, machining centers for optical lens production are not known to have high pressure coolant as is more common in metal workshops and factories.

While some of the inventive aspects below relate to even a tool with a single cutting element (brazed or replaceable), and therefore the language “a cutting element” or “at least one cutting element” is used, it should be understood that a plurality of cutting elements is typically preferred for milling applications.

In view of the existing conditions described above, it is an object of the present application to provide a new and improved milling tool as well as other components of an assembly comprising such milling tool.

It should be understood that while the specific features developed were particularly beneficial for the optical lens milling application described above, it is also conceivable that different milling tools and assemblies comprising same may also be improved with features or aspects of the present invention.

### SUMMARY OF THE INVENTION

The present invention was developed to find a way to provide coolant to increase the tool life of the cutting elements for the above-described milling tool.

Such development was complex due to the high rotational speeds involved, as well as the unusual requirement of a larger amount of coolant for superhard cutting elements, particularly PCD, which less benefits from coolant (especially where heat transfer is divided among many cutting elements) than non-superhard materials.

According to one aspect of the present invention, a coolant sleeve was developed which remains static (connected to a standard machining interface which is not shown) relative to the rotating milling tool.

According to another aspect of the present invention, the sleeve, while not in contact with the milling tool, is in extremely close proximity to the milling tool's head portion to ensure the coolant (not shown) enters head coolant passageways of the milling tool (to reach the cutting elements) and does not excessively exit a gap (i.e. a small “separation distance”) between the milling tool and sleeve.

It will be understood that this is no simple undertaking, since the high rotational speed of the milling tool can cause the coolant to easily exit any gap, yet can be a cause of damage or danger, should the milling tool suddenly contact the static sleeve. Such unintended contact could be caused by vibration, cutting forces, etc.

According to yet another aspect of the present invention, it was conceived to provide a head coolant obstruction arrangement (or “head labyrinth”) to the milling tool which may further reduce unintended loss of coolant through the gap between the sleeve and milling tool.

According to yet another aspect of the present invention, it was conceived to provide a shank coolant obstruction arrangement (or “shank labyrinth”) to the milling tool which may further reduce unintended loss of coolant through the gap between the sleeve and milling tool.

According to yet another aspect of the present invention, it was conceived to provide a sleeve coolant obstruction arrangement (or “sleeve labyrinth”) to the milling tool which may further reduce unintended loss of coolant through the gap between the sleeve and milling tool.

It should be understood that the features of the separation distance and the above-said coolant obstruction arrangements each individually contribute to the intended purpose of assisting coolant reach the intended location, and therefore a milling tool, sleeve or tool assembly according to the present invention can have any one of or a combination of any of said features.

Finally, due to the unique high rotational speed, it was found that directing the coolant to a desired part of the cutting element (in these embodiments, the desired part being a main cutting edge of the of the cutting element) was ineffective due to centrifugal forces causing the coolant to be redirected away from the desired part.

Accordingly, according to yet another aspect of the present invention, it was found beneficial to direct the coolant away from a mid-point of the main cutting edge in the expectation that the high rotational speed of the milling tool would create a correction in direction of the coolant.

Similarly, it should be understood that the above-said feature of directing the coolant is believed to be independent of the coolant obstruction arrangements, and separation distance, but a milling tool having one or more of said features is believed to be beneficial.

The above aspects will now be described in more detail.

According to an aspect of the present invention, there is provided a milling tool comprising: a shank portion; and a head portion extending from the shank portion; a rotation axis extends along the shank portion and defining: a forward direction from the shank portion towards the head portion; a rearward direction opposite to the forward direction; a radially-outward direction perpendicular to the forward and rearward directions and directed outwardly from the rotation axis; a radially-inward direction opposite to the radially outward-direction; a rotation direction; and a counter-rotation direction opposite to the rotation direction; the shank portion comprising: a shank rear end; a shank forward end located closer than the shank rear end to the head portion; and a shank external surface; the head portion comprising: a head external surface; a head internal surface located closer than the head external surface to the shank portion; and a head coolant inlet opening out to the head internal surface; a head coolant outlet opening out to the head external surface; a head coolant passageway extending from the head coolant inlet to the head coolant outlet and comprising a linear portion extending to the head coolant outlet, the linear portion defining a passageway plane extending parallel adjacent to the head coolant outlet; the head external surface comprising: a plurality of alternating flutes and cutting portions; each cutting portion comprising a cutting element recess which is recessed in the counter-rotation direction and having a centerpoint; and a central plane; the central plane fulfilling at least one of the following conditions: the central plain contains the centerpoint; the central plane extends at a 45° angle (also called a central plane angle μ) between the forward direction and the radially-outward direction; and each cutting portion further comprises a cutting element mounted to the cutting recess, the cutting element comprising a main cutting edge having a mid-point, and the central plain contains the mid-point; wherein the passageway plane is directed more in the forward direction than towards the central plane such that it forms an off-center angle β therewith.

It should be understood that the inventive concept is to direct the coolant away from a desired area to be cooled, taking into account the redirection that the extremely high rotational speed will provide to the coolant flow. Thus the differing definitions above take into account the various differently designed tools that may be improved with this feature.

Below are a number of aspects which provide features designed to reduce coolant loss due to the high rotational speeds.

According to an aspect of the present invention, there is provided a milling tool comprising: a shank portion; and a head portion extending from the shank portion; a rotation axis extends along the shank portion and defining: a forward direction from the shank portion towards the head portion; a rearward direction opposite to the forward direction; a radially-outward direction perpendicular to the forward and rearward directions and directed outwardly from the rotation axis; a radially-inward direction opposite to the radially outward-direction; a rotation direction; and a counter-rotation direction opposite to the rotation direction; the shank portion comprising: a shank rear end; a shank forward end located closer than the shank rear end to the head portion; and a shank external surface; the head portion comprising: a head external surface; a head internal surface located closer than the head external surface to the shank portion; and a head coolant inlet opening out to the head internal surface; a head coolant outlet opening out to the head external surface; a head coolant passageway extending from the head coolant inlet to the head coolant outlet; the head external surface comprising: a plurality of alternating flutes and cutting portions; each cutting portion comprises a cutting element recess; wherein: the head internal surface is formed with a peripherally extending head coolant obstruction arrangement comprising a head ridge which extends rearward of an adjacent head portion of the head internal surface, the adjacent head portion being located radially inward of the head ridge.

According to an aspect of the present invention, there is provided a milling tool comprising: a shank portion; and a head portion extending from the shank portion; a rotation axis extends along the shank portion and defining: a forward direction from the shank portion towards the head portion; a rearward direction opposite to the forward direction; a radially-outward direction perpendicular to the forward and rearward directions and directed outwardly from the rotation axis; a radially-inward direction opposite to the radially outward-direction; a rotation direction; and a counter-rotation direction opposite to the rotation direction; the shank portion comprising: a shank rear end; a shank forward end located closer than the shank rear end to the head portion; and a shank external surface; the head portion comprising: a head external surface; a head internal surface located closer than the head external surface to the shank portion; and a head coolant inlet opening out to the head internal surface; a head coolant outlet opening out to the head external surface; a head coolant passageway extending from the head coolant inlet to the head coolant outlet; the head external surface comprising: a plurality of alternating flutes and cutting portions; wherein: at the shank rear end, the shank external surface is formed with a peripherally extending shank coolant obstruction arrangement comprising a shank ridge which extends in the radially-outward direction more than an adjacent shank portion of the shank external surface located in the forward direction more than the shank ridge.

According to an aspect of the present invention, there is provided a coolant sleeve having a basic cylindrical shape and comprising: a machine end comprising a connection arrangement; a lower end opposite to the machine end; a sleeve external surface connecting the machine end and the lower end; a sleeve internal surface connecting the machine end and the lower end, and located closer than the sleeve external surface to the shank portion; a sleeve coolant inlet opening out to the sleeve external surface; a sleeve coolant outlet opening out to the sleeve internal surface; a sleeve coolant passageway extending from the sleeve coolant inlet to the sleeve coolant outlet; a sleeve axis defining: a forward direction from the machine end towards the lower end; a rearward direction opposite to the forward direction; a radially-outward direction perpendicular to the forward and rearward directions and directed outwardly from the sleeve axis; and a radially-inward direction opposite to the radially outward-direction; wherein: the lower end is formed with a peripherally extending sleeve coolant obstruction arrangement comprising a sleeve ridge which extends forward of an adjacent sleeve portion of the lower end, the adjacent sleeve portion located radially inward of the sleeve ridge.

According to an aspect of the present invention, there is provided a tool assembly comprising: a milling tool according to any one of the previous aspects; a sleeve; and a cutting element mounted to the milling tool.

According to an aspect of the present invention, there is provided a tool assembly comprising: a milling tool; a sleeve according to the aspect above; and a cutting element mounted to the milling tool.

According to an aspect of the present invention, there is provided a tool assembly comprising: a milling tool; and a sleeve; a cutting element; the milling tool comprising: a shank portion; and a head portion extending from the shank portion; a rotation axis extends along the shank portion and defining: a forward direction from the shank portion towards the head portion; a rearward direction opposite to the forward direction; a radially-outward direction perpendicular to the forward and rearward directions and directed outwardly from the rotation axis; a radially-inward direction opposite to the radially outward-direction; a rotation direction; and a counter-rotation direction opposite to the rotation direction; the shank portion comprising: a shank rear end; a shank forward end located closer than the shank rear end to the head portion; and a shank external surface; the head portion comprising: a head external surface; a head internal surface located closer than the head external surface to the shank portion; and a head coolant inlet opening out to the head internal surface; a head coolant outlet opening out to the head external surface; a head coolant passageway extending from the head coolant inlet to the head coolant outlet and comprising a linear portion extending to the head coolant outlet, the linear portion defining a passageway plane extending parallel adjacent to the head coolant outlet; the head external surface comprising: a plurality of alternating flutes and cutting portions; the sleeve has a basic cylindrical shape and a sleeve axis and comprises: a machine end in turn comprising a connection arrangement; a lower end opposite to the machine end; a sleeve external surface connecting the machine end and the lower end; a sleeve internal surface connecting the machine end and the lower end, and located closer than the sleeve external surface to the shank portion; a sleeve coolant inlet opening out to the sleeve external surface; a sleeve coolant outlet opening out to the sleeve internal surface; a sleeve coolant passageway extending from the sleeve coolant inlet to the sleeve coolant outlet; wherein: the sleeve encircles the shank portion and is spaced-apart therefrom: the sleeve lower end is adjacent to the head internal surface and is spaced-apart therefrom by separation distance SD fulfilling the condition 0.00 mm<SD<1.00 mm.

According to any one of the above aspects, the following are preferred features:
a. A head external surface can have a central plane. More precisely, each cutting element recess can have a central plane. The central plane can contain a centerpoint of the cutting element recess. The central plane can additionally or alternatively extend at a 45° angle between the forward direction and the radially-outward direction. The central plane can additionally or alternatively contain a mid-point of a cutting element.
b. A head coolant passageway can comprise a linear portion extending to the head coolant outlet. The linear portion can define a passageway plane extending parallel adjacent to the head coolant outlet; wherein the passageway plane is directed more in the forward direction than towards the central plane such that it forms an off-center angle β therewith.
c. A passageway plane can be directed more in a forward direction than towards the central plane such that it forms an off-center angle β therewith. The off-center angle β can fulfill the condition: 5°<β<40°, preferably 10°<β<30°, and most preferably 15°<β<25°.
d. At a shank rear end, a shank external surface can be formed with a peripherally extending shank coolant obstruction arrangement comprising a shank ridge which extends in a radially-outward direction more than an adjacent shank portion of the shank external surface located in the forward direction more than the shank ridge (i.e. the adjacent shank portion located forward of the shank ridge). The shank ridge can be shaped as an annular lip, preferably a circular annular lip.
e. A shank coolant obstruction arrangement can comprise an additional shank ridge which extends in the radially-outward direction (i.e. extends radially outward) more than the adjacent shank portion and is located in the forward direction more than (i.e. located forward of) the adjacent shank portion. The additional shank ridge can be shaped as an annular lip, preferably a circular annular lip.
f. A head internal surface can be formed with a peripherally extending head coolant obstruction arrangement comprising a head ridge which extends in the rearward direction more than an adjacent head portion of the head internal surface located in the radially-inward direction more than the head ridge. The head ridge can be shaped as an annular lip, preferably a circular annular lip.
g. A head coolant obstruction arrangement can comprise an additional head ridge which extends in the rearward direction more than the adjacent head portion (i.e. rearward of the adjacent head portion) and is located in the radially-inward direction more than the adjacent head portion (i.e. is located radially inward of the adjacent head portion). The additional head ridge can be shaped as an annular lip, preferably a circular annular lip.
h. A head coolant outlet can be elongated in the forward and rearward directions. Preferably, the coolant outlet is elongated in the same direction as an adjacent rake surface of a cutting element for better coolant thereof. Even more preferably, the coolant outlet is elongated in the same direction as a cutting element height of a cutting element (in cases where the cutting element is not circular the cutting element height is a largest dimension of the cutting element parallel to the rake surface of the cutting element.
i. While it will be understood that a milling tool according to the present invention can comprise a plurality of head coolant outlets per flute (since they open out to the flute) or per cutting portion (if one wishes to define it as such), preferably there is only a single elongated outlet per flute or cutting portion. This is preferred because at the high rotational speeds the traditional circular outlet holes, which are the easiest to produce with traditional drilling methods, do not provide optimal dispersion of coolant along a cutting element. Nonetheless, it is feasible to provide a milling tool according to the present invention with a plurality of head coolant outlets per flute or cutting portion, which may also have a traditional circular cross sectional shape.
j. A head coolant outlet is preferably oval-shaped. Such shape, while more difficult to produce than a circular cross section, was found to provide better coolant distribution along a cutting element at high rotational speeds.
k. A head coolant outlet can have a head coolant outlet height HO and a cutting element directly adjacent thereto can have a cutting element height HC, and they can fulfill the condition: 0.1 HC<HO<HC, preferably 0.2 HC<HO<0.8 HC, and most preferably 0.3 HC<HO<0.5 HC. Advantageously a single, relatively small, head coolant outlet can provide an accelerated coolant flow for effective cooling.
l. A head coolant outlet can be closer to the cutting element recess than any other adjacent surface of a cutting portion. Stated differently, in a direction facing the head coolant outlet, the head coolant outlet can be located directly adjacent to a cutting element. Alternatively defined, in a direction facing the head coolant outlet, no gap therebetween is visible between the head coolant outlet and a cutting element. Defined differently, in a side view of a cutting element, the head coolant outlet is directly adjacent to a cutting element. Regardless of which of these definitions is used, it has been found that keeping the head coolant outlet as close as possible to the cutting element allows for more coolant to reach a desired location on the cutting element.
m. Preferably, there are at least eight cutting portions, preferably at least ten cutting portions.
n. The milling tool can comprise at least one cutting element. More precisely, each cutting portion can comprise a cutting element. Each of the at least one cutting elements can be directly adjacent to the head coolant outlet. Preferably the at least one cutting element can be more than 5 cutting elements, more preferably more than 10 cutting elements.
o. The head coolant outlet opening can comprise a plurality of head coolant outlet openings. Each one of the plurality of flutes can have at least one of the plurality of head coolant outlet opening out thereto.
p. The milling tool can comprising a cutting element directly adjacent to the head coolant outlet, wherein cutting element recess has a centerpoint and a central plane containing the centerpoint.
q. One or more cutting elements can be made of a superhard material, preferably PCD.
r. A cutting element can comprise a main cutting edge. To elaborate, cutting elements can often have ramping edges, wiper edges etc. A main cutting edge is the primary, and typically the largest, cutting edge of a cutting element. It should be understood that in the present application, a main cutting edge relates to an edge positioned for operation, in embodiments where an indexable cutting element is used with a milling tool of the present invention.
s. A sleeve's lower end can be formed with a peripherally extending sleeve coolant obstruction arrangement comprising a sleeve ridge which extends in the forward direction more than an adjacent sleeve portion of the lower end located in the radially-inward direction more than the sleeve ridge. Stated differently, the additional sleeve ridge extends forward of the adjacent sleeve portion, the additional sleeve ridge being located radially inward of the adjacent sleeve portion. The sleeve ridge can be shaped as an annular lip, preferably a circular annular lip.
t. The sleeve coolant obstruction arrangement can comprise an additional sleeve ridge which extends in the forward direction more than the adjacent sleeve portion, the additional sleeve ridge being located in the radially-inward direction more than the adjacent sleeve portion. The additional sleeve ridge can be shaped as an annular lip, preferably a circular annular lip.
u. A tool assembly can comprise a sleeve which encircles a shank portion of a milling tool and is spaced-apart therefrom. The sleeve's lower end can be adjacent to the head internal surface and is spaced-apart therefrom by separation distance SD fulfilling the condition 0.00 mm<SD<1.00 mm. Preferably, the separation distance SD fulfills the condition: SD<0.60 mm, preferably SD<0.45 mm and most preferably SD<0.30 mm. Preferably, the separation distance SD fulfills the condition: SD>0.05 mm, preferably SD>0.10 mm and most preferably SD>0.15 mm.
v. A sleeve can comprise a plurality of coolant inlets. This was found to be advantageous for the present invention which is designed for machining centers typically only provided with low pressure pumps (i.e. pumps which provide coolant at 6 bar and 60 liters per minute). Further, multiple coolant inlets allow a larger amount of coolant to enter the sleeve without an excessively large inlet cross section. Nonetheless, it is believed the present invention is also feasible for higher pressure coolant supply.

### BRIEF DESCRIPTION OF THE DRAWINGS

For a better understanding of the subject matter of the present application, and to show how the same may be carried out in practice, reference will now be made to the accompanying drawings, in which:

FIG. 1A is a perspective view of a tool assembly according to the present invention;

FIG. 1B is a perspective side view of the tool assembly in FIG. 1A, with a schematic coolant flow shown exiting the tool assembly to exemplify an exiting direction of the flow if it would not be affected by centrifugal forces;

FIG. 1C is an exploded side view of the tool assembly in FIG. 1A;

FIG. 2A is a perspective view of a milling tool of the tool assembly in FIG. 1A;

FIG. 2B is a top view of the milling tool in FIG. 2A;

FIG. 2C is a side view of the milling tool in FIG. 2A;

FIG. 2D is a bottom view of the milling tool in FIG. 2A;

FIG. 3A is a perspective view of a sleeve of the tool assembly in FIG. 1A;

FIG. 3B is a top view of the sleeve in FIG. 3A;

FIG. 3C is a side view of the sleeve in FIG. 3A;

FIG. 3D is a bottom view of the sleeve in FIG. 3A;

FIG. 3E is another top view of the sleeve, identical to that shown in FIG. 3B;

FIG. 3F is a cross-section view taken along line IIIF-IIIF in FIG. 3E;

FIG. 4A is a perspective view of the tool assembly in FIG. 1, a direction facing a head coolant outlet of the milling tool, with a schematic coolant flow path shown exiting the tool assembly to exemplify an exiting direction of the flow as affected by centrifugal forces;

FIG. 4B is an enlarged view of the encircled portion designated X in FIG. 4A;

FIG. 4C is cross-section view of the tool assembly in FIG. 1A; and

FIG. 5 is a cross-section view of another embodiment of a milling tool according to the present invention.

### DETAILED DESCRIPTION

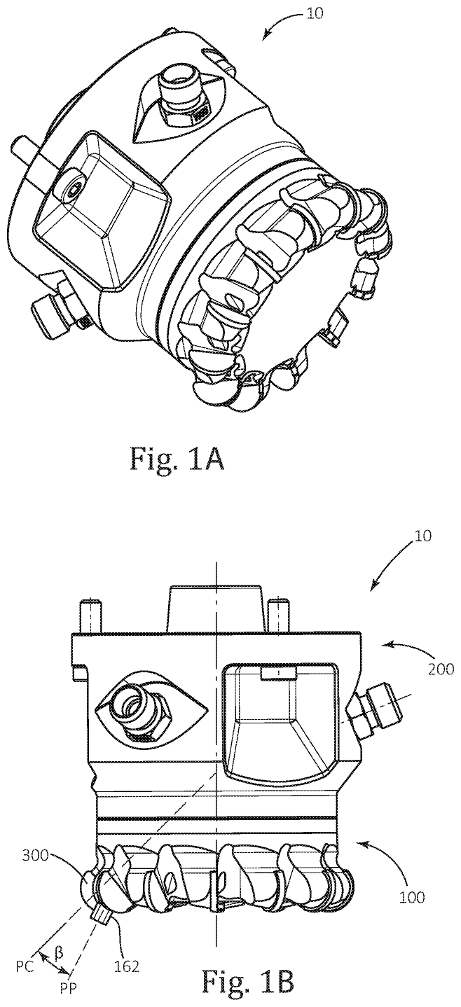

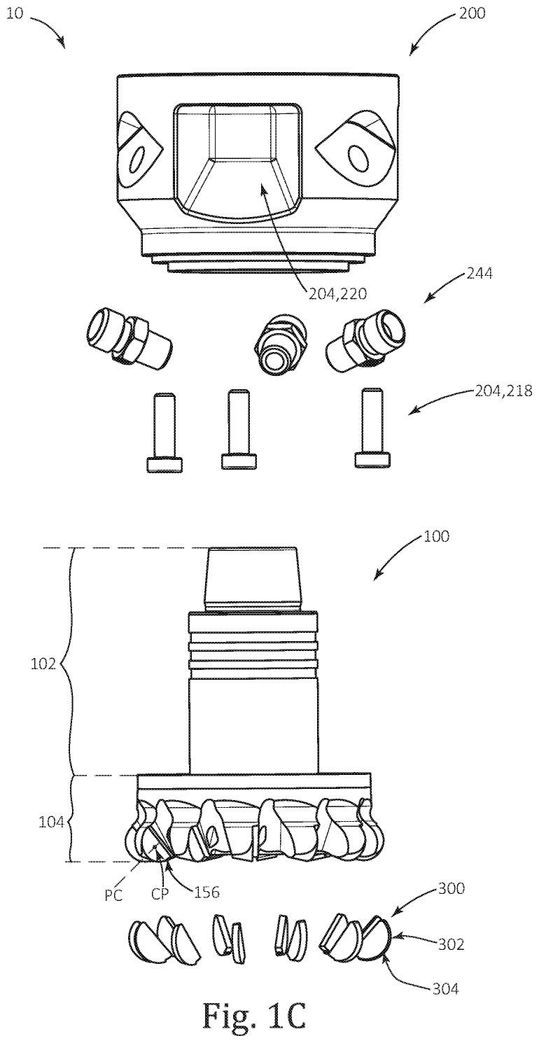

Referring to FIGS. 1A to 1C, there is illustrated an example tool assembly 10 comprising a milling tool 100 and a sleeve 200 encircling a portion of the milling tool 100 and configured to be relatively static to the milling tool 100 when it is rotating.

The milling tool 100 (or, alternatively defined, the tool assembly 10) comprises at least one cutting element 300 mounted to the milling tool.

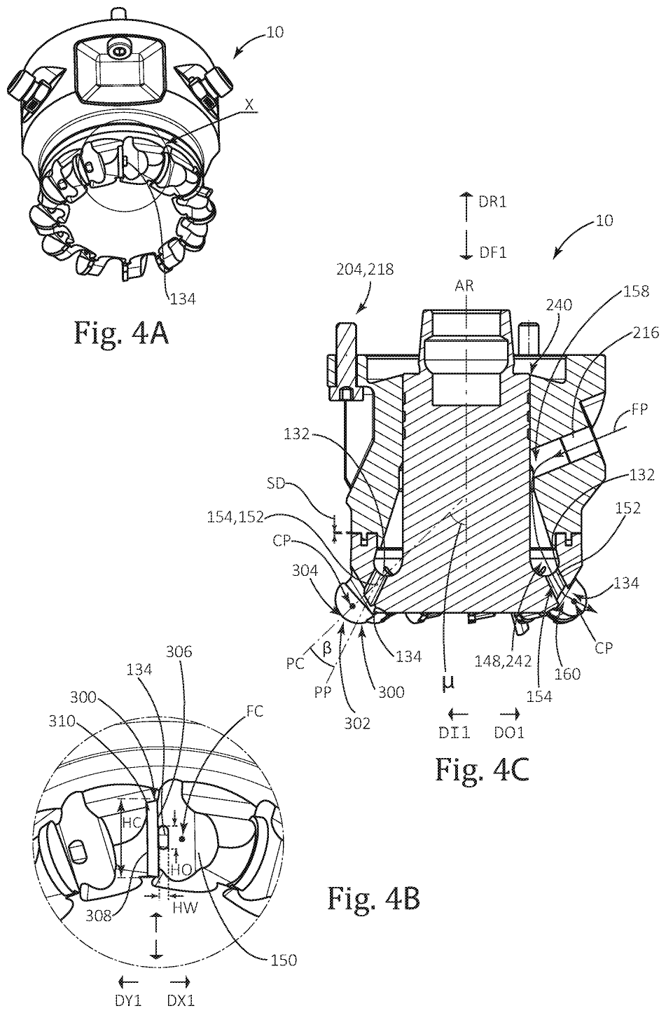

The cutting elements 300 have flat rake and base surfaces 306, 308 (FIG. 4B) connected by a peripheral edge 310, the flat rake and base surfaces 306, 308 having a basic semi-circular shape. The cutting elements 300 are made of Polycrystalline Diamond (PCD) and in the present example there are twelve cutting elements 300.

Each cutting element 300 preferably comprises an arc-shaped main cutting edge 302, which extends approximately 180° and which comprises a mid-point 304.

In FIG. 4B, it is shown that the mounted cutting element 300 has a cutting element height HC, measured parallel to an elongation direction of an adjacent head coolant outlet 134.

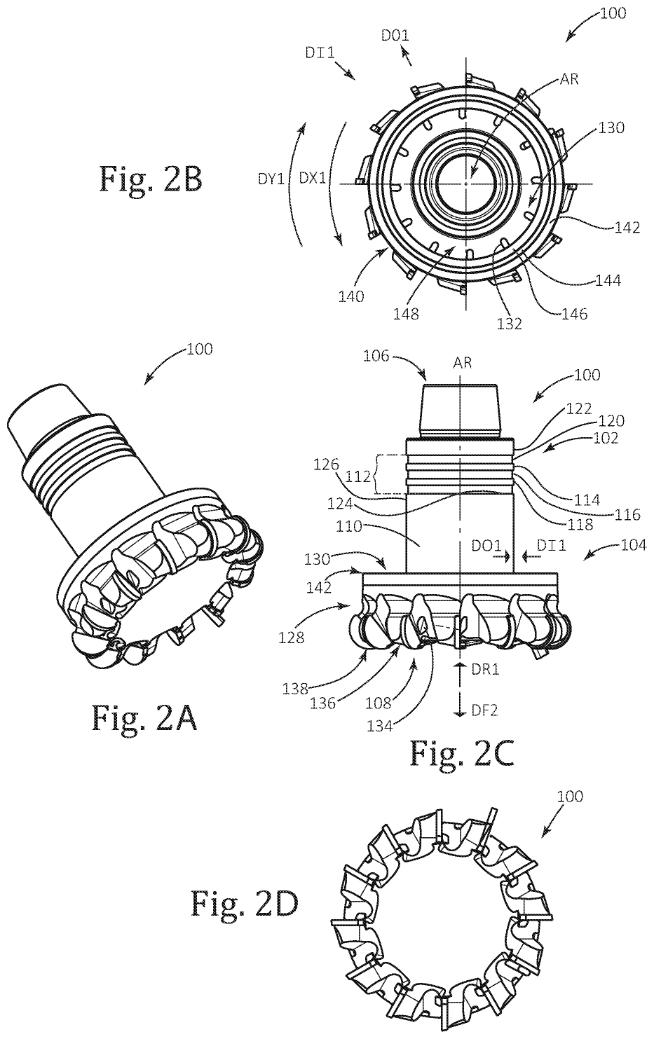

Referring now to also FIGS. 2A to 2D the milling tool 100 comprises a shank portion 102 and a head portion 104 extending from the shank portion 102.

The rotation axis AR extends along the shank portion 102 and defines a forward direction DF1 from the shank portion 102 towards the head portion 104; a rearward direction DR1 opposite to the forward direction DF1; a radially-outward direction DO1 perpendicular to the forward and rearward directions DF1, DR1 and directed outwardly from the rotation axis AR; a radially-inward direction DI1 opposite to the radially outward-direction D01; a rotation direction DX1; and a counter-rotation direction DY1 opposite to the rotation direction DX1.

The shank portion 102 comprises a shank rear end 106; a shank forward end 108 located closer than the shank rear end 106 to the head portion 104; and a shank external surface 110.

At the shank rear end 106, the shank external surface 110 is formed with a peripherally extending shank coolant obstruction arrangement 112 comprising a protruding shank ridge 114 which extends in a radially-outward direction more than an adjacent shank recess portion 116 of the shank external surface, the shank recess portion 116 being located forward of the shank ridge 114. The shank ridge 114 is shaped as a circular annular lip.

The shank coolant obstruction arrangement 112 also comprises an additional protruding shank ridge 118 located forward of the shank recess portion 116, and shaped as a circular annular lip.

In embodiments with both the shank ridge 114 and additional shank ridge 118, the adjacent shank recess portion 116 can be considered an annular groove.

A first additional annular groove 120 is shown rearward of the shank ridge 114, and is forward of another portion 122 of the shank external surface 110.

A second additional annular groove 124 is shown forward of the additional shank ridge 118, and is rearward of yet another portion 126 of the shank external surface 110.

The head portion 104 comprises a head external surface 128, a head internal surface 130 located closer than the head external surface 128 to the shank portion 102, and a head coolant inlet 132 opening out to the head internal surface 130; a head coolant outlet 134 opening out to the head external surface 128.

The head external surface 128 comprising a plurality of alternating flutes 136 and cutting portions 138.

The head internal surface 130 is further formed with a peripherally extending head coolant obstruction arrangement 140.

The head coolant obstruction arrangement 140 comprises an upwardly protruding head ridge 142 shaped as a circular annular lip and which extends in the rearward direction DR1 more than an adjacent head portion 144 of the head internal surface located in the radially-inward direction more than the head ridge 142. The transition from the head ridge 142 to the adjacent head portion 144 may be considered a downward and radially inward circumferential step.

The head coolant obstruction arrangement 140 can further comprise an additional head ridge 146 shaped as a circular annular lip and which extends in the rearward direction DR1 more than the adjacent head portion 144 and is located in the radially-inward direction DI1 more than the adjacent head portion 144. The transition from the adjacent heard portion 144 to the additional head ridge 146 may be considered an upward and radially inward circumferential step.

In embodiments with both the head ridge 142 and additional head ridge 146, the adjacent head portion 144 can be considered an annular groove.

Further inward of the head coolant obstruction arrangement 140 is a head reservoir 148 which can be useful in allowing coolant to stabilize and then proceed to enter each head coolant inlet 132.

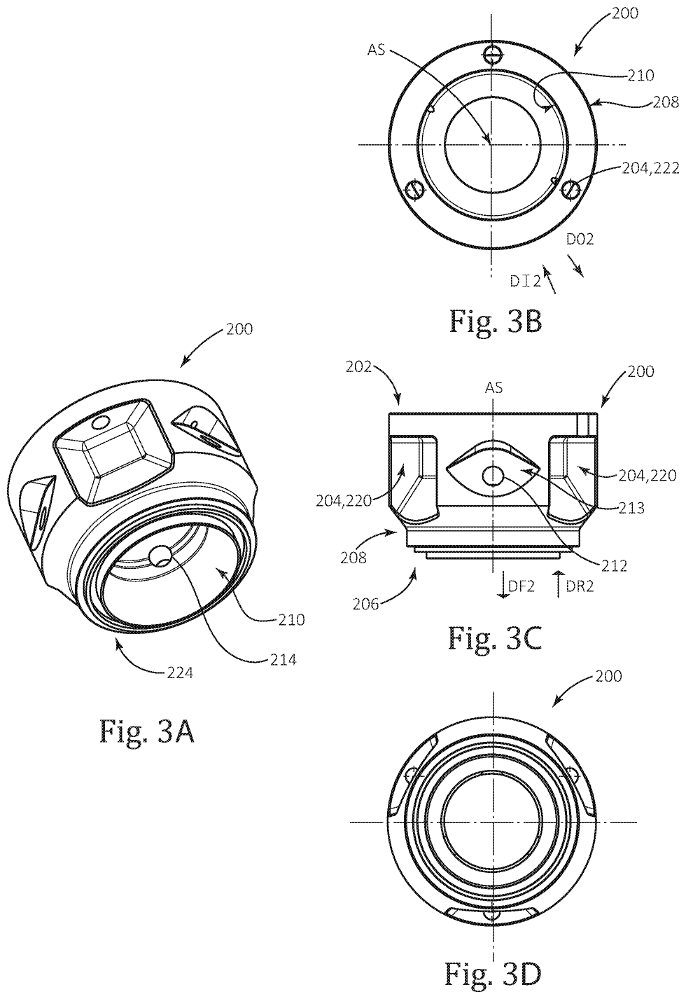

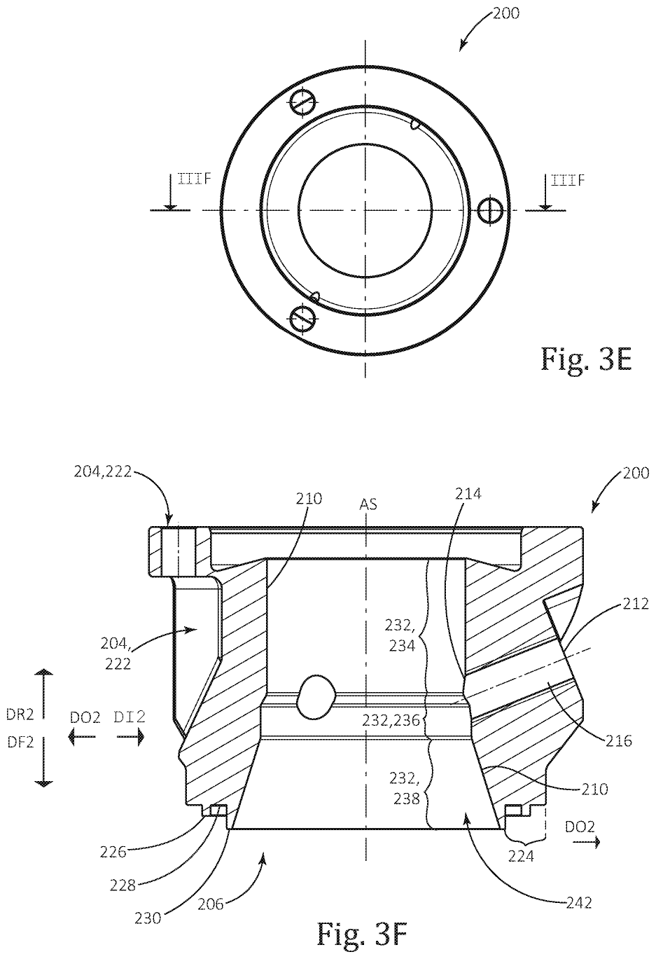

Referring now to FIGS. 3A to 3F, the sleeve 200 has a basic cylindrical shape and comprises; a machine (upper) end 202 in turn comprising a connection arrangement 204; a lower end 206 opposite to the machine end 204; a sleeve external surface 208 connecting the machine end 204 and the lower end 206; a sleeve internal surface 210 connecting the machine end 202 and the lower end 206, and located closer than the sleeve external surface 208 to the shank portion 102; a sleeve coolant inlet 212 opening out to the sleeve external surface 208; a sleeve coolant outlet 214 opening out to the sleeve internal surface 210; a sleeve coolant passageway 216 (FIG. 3F) extending from the sleeve coolant inlet 212 to the sleeve coolant outlet 214.

The connection arrangement 204 comprises a circumferentially spaced plurality of screws 218 housed in recessed areas 220 and extending through screw holes 222 to fasten to a machine interface (not shown).

Due to the connection to the machine interface (not shown), the sleeve 200 remains static relative to the rotating milling tool 100.

The sleeve 200 has a sleeve axis AS, which could alternatively be defined with the same directions as the milling tool 100. Since the sleeve axis and rotation axis are coaxial, the directions defined in relation to the milling tool 100 will be used when discussing the tool assembly 10, for convenience only.

Thus, the sleeve axis AS defines a sleeve forward direction DF2 from the machine end 202 towards the lower end 206; a sleeve rearward direction DR2 opposite to the sleeve forward direction DF2; a sleeve radially-outward direction DO2 perpendicular to the forward and rearward directions DF2, DR2 and directed outwardly from the sleeve axis AS; and a radially-inward direction D12 opposite to the radially outward-direction DO2.

The sleeve's lower end 206 is formed with a peripherally extending sleeve coolant obstruction arrangement 224 comprising a protruding sleeve ridge 226 shaped as a circular annular lip and which extends in the forward direction more than an adjacent sleeve recess portion 228 of the lower end 206 located in the radially-inward direction more than the sleeve ridge 226.

The sleeve coolant obstruction arrangement 224 can further comprise an additional sleeve ridge 230 shaped as a circular annular lip and which extends in the sleeve forward direction DF2 more than the adjacent sleeve recess portion 228.

In embodiments with both the protruding sleeve ridge 226 and additional sleeve ridge 230, the adjacent sleeve recess portion 228 can be considered an annular groove.

Referring particularly to FIGS. 3E and 3F, the sleeve's internal surface 210 defines a chamber 232.

The chamber 232 comprises a first (upper) sub-chamber 234 having a diameter slightly larger than the shank portion 102 (to define a gap 240 therebetween as designated in FIG. 4C, however the gap is so small that it is not clearly visible, thus the numeral 240 is merely to assist understanding), a second (middle) sub-chamber 236 slightly larger in diameter than the first sub-chamber 234, and a third (lower) sub-chamber 238 even larger in diameter than the second sub-chamber 236. The sleeve's internal surface 210 tapering in the sleeve radially-outward direction DO2 as it increases in the forward direction DF2. This allows the third sub-chamber 238 to provide a sleeve reservoir 242.

The sleeve reservoir 242 is believed to be beneficial in stabilizing coolant in order to assist the coolant to enter each head coolant inlet 132.

The sleeve 200 can optionally comprise connectors 244 (FIG. 1C), configured to attach to the sleeve coolant inlets 212 and supply pipes (not shown). In such case, the sleeve external surface 208 can be formed with a sleeve inlet recess 213 for each sleeve coolant inlet 212.

Referring now to FIGS. 4A and 4B, the head coolant outlet 134 is elongated in the forward and rearward directions DF1, DF2, and is oval-shaped.

More precisely, the head coolant outlet 134 has a head coolant outlet height HO and a head coolant outlet width HW which is smaller than the head coolant outlet height HO.

As shown the head coolant outlet 134 is directly adjacent to the cutting element 300. The head coolant outlet 134 is also closer than a flute centerpoint FC to the cutting element 300. Alternatively defined, the head coolant outlet 134 is also closer than an adjacent surface 150, located in the rotation direction DX1 from the cutting element 300 described, to the cutting element 300.

Referring now also to FIG. 4C, a head coolant passageway 152 extends from the head coolant inlet 132 to the head coolant outlet 134 and comprising a linear portion 154 extending to the head coolant outlet 134, the linear portion 154 defining a passageway plane PP extending parallel adjacent to the head coolant outlet 134. In the present embodiment the entire head coolant passageway 152 extends in a linear or straight manner, however it will be understood that only a portion thereof which is adjacent to the head coolant outlet 134 determines the direction of coolant flow exiting therefrom.

The passageway plane PP is directed more in the forward direction than towards the central plane such that it forms an off-center angle β therewith.

Each cutting portion 138 further comprises a cutting element recess 156 (FIG. 1C) which is recessed in the counter-rotation direction and has a centerpoint CP (FIG. 1C; shown schematically on the cutting element for explanatory purposes only in FIG. 4C); and a central plane PC containing the centerpoint CP.

Notably, the coolant flow path FP is shown in FIG. 4C. The coolant (not shown) enters the sleeve coolant passageway 216 until it impacts the shank portion 102 and enters the second sub-chamber 236 (since a gap between the shank portion 102 and the sleeve 200 is designed to be smaller at the first sub-chamber 234 so that the coolant will be redirected at a first bend 158 towards the head portion 104 in the forward direction DF1). The shank coolant obstruction arrangement 112 further assists in reducing coolant from exiting in the rearward direction DR1 by impeding coolant flow.

Subsequent to the first bend 158 the coolant reaches said head reservoir 148 and sleeve reservoir 242 (which coincide) and consequently enters each head coolant inlet 132. The sleeve and head coolant obstruction arrangements 140, 224 assist in reducing coolant from exiting in the radially outward direction DO1 and rearward direction DR1.

After the coolant exits the head coolant outlet 134 the coolant flow path FP comprises a second bend 160 caused by centrifugal forces, which thus directs the coolant more towards the centerpoint CP of the cutting element recess 156 along the central plane PC, than the initial direction from the head coolant outlet 134 along the passageway plane PP. In FIG. 1B there is a schematic coolant flow 162 shown that would be the direction of the coolant if it would not be affected by centrifugal forces (and therefore it would not cool most of the cutting element 300, however this will not be the case due to the high rotational speed of the milling tool 100).

Notably, the sleeve lower end is adjacent to the head internal surface and is spaced-apart therefrom by separation distance SD.

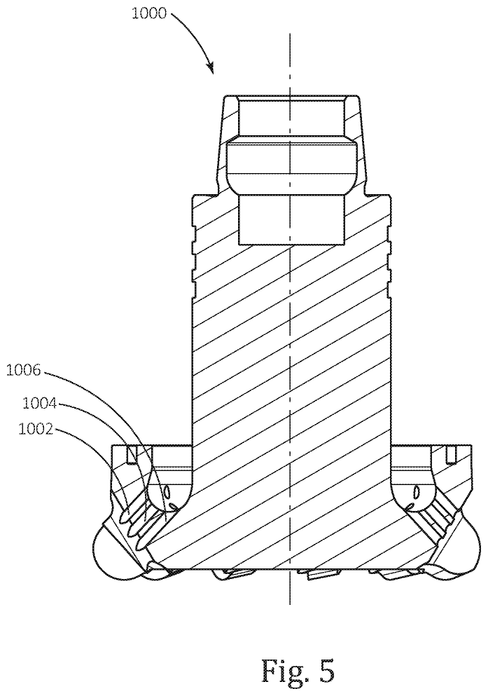

Referring to FIG. 5, there is shown another embodiment of the milling tool 1000, it will be understood that the only substantive difference are the head coolant passageways and shapes thereof. In this example there are three head coolant passageways 1002, 1004, 1006 per flute or cutting portion, each having a traditional circular cross section, including circular outlet holes.

1. A milling tool comprising:
a shank portion; and
a head portion extending from the shank portion;
a rotation axis extends along the shank portion and defining:
a forward direction from the shank portion towards the head portion;
a rearward direction opposite to the forward direction;
a radially-outward direction perpendicular to the forward and rearward directions and directed outwardly from the rotation axis;
a radially-inward direction opposite to the radially outward-direction;
a rotation direction; and
a counter-rotation direction opposite to the rotation direction;
the shank portion comprising:
a shank rear end;
a shank forward end located closer than the shank rear end to the head portion; and
a shank external surface;
the head portion comprising:
a head external surface;
a head internal surface located closer than the head external surface to the shank portion; and
a head coolant inlet opening out to the head internal surface;
a head coolant outlet opening out to the head external surface;
a head coolant passageway extending from the head coolant inlet to the head coolant outlet;
the head external surface comprising:
a plurality of alternating flutes and cutting portions;
each cutting portion comprises a cutting element recess;
wherein:
the head internal surface is formed with a peripherally extending head coolant obstruction arrangement comprising a head ridge which extends rearward of an adjacent head portion of the head internal surface, the adjacent head portion being located radially inward of the head ridge.

2. The milling tool according to claim 1, wherein the head ridge is shaped as an annular lip.

3. The milling tool according to claim 1, wherein the head coolant obstruction arrangement comprises an additional head ridge which extends rearward of the adjacent head portion and is located radially inward of the adjacent head portion.

4. The milling tool according to claim 3, wherein the additional head ridge is shaped as an annular lip.

5. The milling tool according to claim 1, wherein at the shank rear end, the shank external surface is formed with a peripherally extending shank coolant obstruction arrangement comprising a shank ridge which extends radially outward of an adjacent shank portion of the shank external surface, the adjacent shank portion located forward of the shank ridge.

6. The milling tool according to claim 5, wherein the shank ridge is shaped as an annular lip.

7. The milling tool according to claim 5, wherein the shank coolant obstruction arrangement comprises an additional shank ridge which extends radially outward of the adjacent shank portion and is located forward of the adjacent shank portion.

8. The milling tool according to claim 1, wherein the cutting element recess has a centerpoint and a central plane containing the centerpoint; and the head coolant passageway comprises a linear portion extending to the head coolant outlet, the linear portion defining a passageway plane extending parallel adjacent to the head coolant outlet; wherein the passageway plane is directed more in the forward direction than towards the central plane such that it forms an off-center angle β therewith.

9. The milling tool according to claim 8, wherein the off-center angle β fulfills the condition: 5°<β<40°.

10. The milling tool according to claim 1, wherein the head coolant outlet is elongated.

11. The milling tool according to claim 10, wherein the head coolant outlet is elongated in an elongation direction, a head coolant outlet height HO is measured parallel to an elongation direction, and the milling tool further comprises a cutting element directly adjacent to the head coolant outlet, the cutting element having a cutting element height HC, measured parallel to an elongation direction, fulfilling the condition: 0.1 HC<HO<HC.

12. The milling tool according to claim 1, wherein the head coolant outlet is closer to the cutting element recess than any other adjacent surface of the cutting portion.

13. The milling tool according to claim 12, wherein in a side view of a cutting element, the head coolant outlet is directly adjacent to the cutting element.

14. The milling tool according to claim 1, wherein there are at least eight cutting portions.

15. The milling tool according to claim 1, wherein the milling tool comprises one or more cutting elements which are made of a superhard material.

16. A coolant sleeve having a basic cylindrical shape and comprising:
a machine end comprising a connection arrangement;
a lower end opposite to the machine end;
a sleeve external surface connecting the machine end and the lower end;
a sleeve internal surface connecting the machine end and the lower end, and located closer than the sleeve external surface to the shank portion;
a sleeve coolant inlet opening out to the sleeve external surface;
a sleeve coolant outlet opening out to the sleeve internal surface;
a sleeve coolant passageway extending from the sleeve coolant inlet to the sleeve coolant outlet;
a sleeve axis defining:
a forward direction from the machine end towards the lower end;
a rearward direction opposite to the forward direction;
a radially-outward direction perpendicular to the forward and rearward directions and directed outwardly from the sleeve axis; and
a radially-inward direction opposite to the radially outward-direction;
wherein:
the lower end is formed with a peripherally extending sleeve coolant obstruction arrangement comprising a sleeve ridge which extends forward of an adjacent sleeve portion of the lower end, the adjacent sleeve portion located radially inward of the sleeve ridge.

17. The coolant sleeve according to claim 16, wherein the sleeve coolant obstruction arrangement comprises an additional sleeve ridge which extends forward of the adjacent sleeve portion, the additional sleeve ridge being located radially inward of the adjacent sleeve portion.

18. A tool assembly comprising:
a milling tool according to claim 1;
a coolant sleeve having a basic cylindrical shape secured to the milling tool; and
at least one cutting element mounted to the milling tool.

19. A tool assembly according to claim 18, wherein the coolant sleeve comprises:
a machine end having a connection arrangement;
a lower end opposite to the machine end;
a sleeve external surface connecting the machine end and the lower end;
a sleeve internal surface connecting the machine end and the lower end, and located closer than the sleeve external surface to the shank portion;
a sleeve coolant inlet opening out to the sleeve external surface;
a sleeve coolant outlet opening out to the sleeve internal surface;
a sleeve coolant passageway extending from the sleeve coolant inlet to the sleeve coolant outlet;
a sleeve axis defining:
a forward direction from the machine end towards the lower end;
a rearward direction opposite to the forward direction;
a radially-outward direction perpendicular to the forward and rearward directions and directed outwardly from the sleeve axis; and
a radially-inward direction opposite to the radially outward-direction;
wherein:
the lower end is formed with a peripherally extending sleeve coolant obstruction arrangement comprising a sleeve ridge which extends forward of an adjacent sleeve portion of the lower end, the adjacent sleeve portion located radially inward of the sleeve ridge.

20. A tool assembly according to claim 19, wherein the sleeve encircles the shank portion and is spaced-apart therefrom: the sleeve lower end is adjacent to the head internal surface and is spaced-apart therefrom by separation distance SD fulfilling the condition 0.00 mm<SD<1.00 mm.

21. A tool assembly according to claim 20, wherein the separation distance SD fulfills the condition 0.05 mm<SD<0.60 mm.
